(19) United States
(12) Patent Application Publication
(10) Pub. No.: US 2025/0224655 A1
(43) Pub. Date: Jul. 10, 2025

(54) Telescopic Rod

(71) Applicant: Shenzhen Leaderment Technology Co.,Ltd., Shenzhen (CN)

(72) Inventor: Chunbin Li, Shenzhen (CN)

(21) Appl. No.: 18/404,199

(22) Filed: Jan. 4, 2024

(51) Int. Cl. G03B 17/56; F16B 7/10; F16M 13/04

(52) U.S. Cl. CPC G03B 17/561; F16B 7/10; F16M 13/04

(57) ABSTRACT

The present invention discloses a telescopic rod comprising a plurality of sections of sequentially sleeved tube bodies, two adjacent sections of tube bodies being an inner tube and an outer tube respectively, wherein the telescopic rod further comprises an elastic damping structure arranged between gaps of the inner tube and the outer tube; the elastic damping structure comprises a first damping sleeve, a second damping sleeve and a spring, the inner tube is sleeved on inner sides of two damping sleeves, the inner tube is connected to the two damping sleeves, two ends of the spring abut against the two damping sleeves respectively, and the spring drives the first damping sleeve and the second damping sleeve to move in opposite directions; and a third damping sleeve is further sleeved on the outer tube, and the third damping sleeve comprises a snap ring and a limiting member.

### TECHNICAL FIELD

The present invention relates to the technical field of photographic auxiliary tools, and in particular, to a telescopic rod.

### BACKGROUND

A telescopic rod is a light-load product applied in a telescopic rod type, and generally consists of a plurality of sections of pipelines or rod bodies mutually sleeved. As a lightweight photography tool, the telescopic rod is very important to provide stable support during photographing.

At present, the connection between every two adjacent sections of pipe bodies of the telescopic rod often has the problem of shaking and jitter. In one aspect, there are fit gaps between every two adjacent sections of pipe bodies of the telescopic rod, and these gaps are prone to shaking when subjected to external forces. In another aspect, although a damping positioning structure arranged in the conventional telescopic rod can provide stable and durable resistance, the adjustment of the resistance is often difficult to master. If the resistance is too large, manual drawing becomes difficult, and if the resistance is too small, sufficient stability cannot be provided.

### SUMMARY

The present invention is mainly intended to provide a telescopic rod, and aims to design a telescopic rod with an elastic damping structure, so as to solve the technical problems that a fit gap of each section of the tube body in the conventional telescopic rod is large and the telescopic rod is easy to shake.

In order to achieve the above objective, the present invention provides a telescopic rod comprising a plurality of sections of sequentially sleeved tube bodies, two adjacent sections of tube bodies being an inner tube and an outer tube respectively, wherein the telescopic rod further comprises an elastic damping structure arranged between gaps of the inner tube and the outer tube; the elastic damping structure comprises a first damping sleeve, a second damping sleeve and a spring, the inner tube is sleeved on inner sides of the first damping sleeve and the second damping sleeve, the inner tube is connected to the first damping sleeve and the second damping sleeve, two ends of the spring abut against the first damping sleeve and the second damping sleeve respectively, and the spring drives the first damping sleeve and the second damping sleeve to move in opposite directions, so that the inner tube, the elastic damping structure and the outer tube are tightly attached; and a third damping sleeve is further sleeved on the outer tube, the third damping sleeve comprises a snap ring and a limiting member, the snap ring is lapped at one end of the outer tube, the limiting member is formed by extending from the snap ring and extends between the outer tube and the inner tube, and the limiting member cooperates with the first damping sleeve and/or the second damping sleeve to limit the inner tube.

Optionally, a plurality of first elastic structures are convexly provided on one side that is of the first damping sleeve and/or the second damping sleeve and that is close to the outer tube, and the first elastic structure elastically abuts against an inner wall of the outer tube.

Optionally, a first spring seat is arranged on the first damping sleeve, a second spring seat cooperating with the first spring seat is arranged on the second damping sleeve, the spring is arranged between the first spring seat and the second spring seat, inner walls of the first spring seat and the second spring seat are respectively provided with a first mounting groove and a second mounting groove each with an opening at one end, the first mounting groove and the second mounting groove communicate with each other, and two ends of the spring respectively abut against bottoms of the first mounting groove and the second mounting groove.

Optionally, two sides of a tube wall of the inner tube are provided with clearance through holes for the first spring seat and the second spring seat to pass through, and the two clearance through holes are oppositely arranged.

Optionally, the clearance through hole is positioned at an end of the inner tube, the tube wall of the inner tube is further provided with a first mounting hole, and the first damping sleeve and the second damping sleeve are convexly provided with first mounting convex blocks that cooperate with the first mounting holes.

Optionally, a second mounting convex block and a plurality of second elastic structures are convexly arranged on one side that is of the limiting member and that is close to the inner tube, the tube wall of the outer tube is further provided with a second mounting hole cooperating with the second mounting convex block, and the second elastic structure elastically abuts against the inner tube.

Optionally, a spring column is provided on the first mounting groove, and the spring is sleeved outside the spring column.

Optionally, a plurality of arched third elastic structures are convexly arranged on one side that is of the first damping sleeve and/or the second damping sleeve and that faces away from the outer tube.

Optionally, the inner wall of the outer tube is convexly provided with a guide rib, an outer wall of the first damping sleeve and/or the second damping sleeve is provided with a guide groove cooperating with the guide rib, and the first mounting hole on the inner tube is positioned on the guide rib.

Optionally, the telescopic rod is further provided with a top cover and a bottom cover, the top cover is mounted on the inner tube, and the bottom cover is mounted on the outer tube.

The present invention has the beneficial effects that: according to the telescopic rod with the elastic damping structure provided by the present invention, the elastic damping structure is arranged between an end of the inner tube and an inner wall of the outer tube. As the inner tube and damping members slide along the inner wall of the outer tube, with the two damping sleeves provided independently and the spring between the two damping sleeves, where an elastic force of the spring always acts on the inner tube and is transmitted to the outer tube through the damping sleeves at two ends, the inner tube, the elastic damping structure and the outer tube can be always tightly attached, the fit gaps among the inner tube, the elastic damping structure and the outer tube are eliminated, and shaking of the telescopic rod caused by the fit gap of the inner tube body is solved.

Meanwhile, two spring seats that cooperate with each other are extended and formed on two damping sleeves that are mutually independently arranged, the spring is arranged between the two spring seats, so that the spring can be more stably fixed on the two damping sleeves, the telescopic stability and precision of the elastic damping structure are improved, and the telescopic rod is more accurate and reliable in use.

In addition, two sides of a tube wall of the inner tube are provided with clearance through holes for two spring seats to pass through. With this arrangement, the spring can be placed in an inner cavity of the inner tube without occupying the space between the inner tube and the outer tube. This is helpful to eliminate the gaps between the inner tube, the damping sleeves and the outer tube, and eliminate the shaking caused by the gaps.

### BRIEF DESCRIPTION OF DRAWINGS

In order to more clearly illustrate the technical solutions in the embodiments of the present invention or in the prior art, the drawings required to be used in the description of the embodiments or the prior art are briefly introduced below. It is obvious that the drawings in the description below are some embodiments of the present invention, and those of ordinary skill in the art can obtain other drawings according to the structures illustrated in these drawings without creative efforts.

FIG. 1 is a schematic diagram of an overall structure of a telescopic rod according to the present invention;

FIG. 2 is a schematic diagram of a cross-sectional structure of a telescopic rod according to the present invention;

FIG. 3 is a schematic diagram of an overall structure of a telescopic rod according to an embodiment of the present invention;

FIG. 4 is a schematic diagram of an exploded structure of a telescopic rod according to an embodiment of the present invention;

FIG. 5 is a schematic sectional structural diagram along the A-A direction in FIG. 3;

FIG. 6 is a schematic sectional structural diagram along the A-A direction in FIG. 3;

FIG. 7 is a schematic diagram of an exploded structure of an elastic damping structure according to an embodiment of the present invention; and

FIG. 8 is a schematic diagram of another exploded structure of an elastic damping structure according to an embodiment of the present invention.

### DESCRIPTIONS OF REFERENCE NUMERALS

100: tube body; 101: first tube body; 102: second tube body; 103: third tube body; 104: fourth tube body; 105: fifth tube body; 106: sixth tube body; 107: seventh tube body; 200: elastic damping structure; 300: top cover; 400: bottom cover;
1: inner tube; 1a: clearance through hole; 1b: first mounting hole;
2: outer tube; 21: third damping sleeve; 21a: snap ring; 21b: limiting member; 21c: second elastic structure; 21d: second mounting convex block; 22: guide rib; 23: second mounting hole;
3: first damping sleeve; 31: first spring seat; 31a: first mounting groove; 31b: spring column; 4: second damping sleeve; 41: the second spring seat; 41a: second mounting groove; 3a/4a: first mounting convex block; 3b/4b: first elastic structure; 3c: third elastic structure; 4c: guide groove; and
5: spring.

The realization of the objectives, the functional features, and the advantages of the present invention will be further explained in conjunction with the embodiments and with reference to the drawings.

### DETAILED DESCRIPTION OF EMBODIMENTS

The following clearly and completely describes the technical solutions in the embodiments of the present invention with reference to drawings in the embodiments of the present invention. It is clear that the described embodiments are merely a part rather than all of the embodiments of the present invention. All other embodiments obtained by those of ordinary skill in the art based on embodiments of the present invention without creative efforts shall fall within the protection scope of the present invention.

It should be noted that, if directional indications (such as upper, lower, left, right, front and rear) are involved in the embodiments of the present invention, the directional indications are only used to explain the relative positional relationships, the motion situations and the like between individual components under a certain pose (as shown in the drawings), and if the certain pose is changed, the directional indications are changed accordingly.

In addition, if there are descriptions relating to “first”, “second” and the like in the embodiments of the present invention, the descriptions of “first”, “second” and the like are for descriptive purposes only and are not to be construed as indicating or implying relative importance thereof or implicitly indicating the quantities of the indicated technical features. Thus, a feature defined by “first” or “second” may explicitly or implicitly include at least one such feature. In addition, “and/or” appearing herein is meant to include three parallel solutions, and taking “A and/or B” as an example, it includes solution A, or solution B, or both solution A and solution B. In addition, the technical solutions among various embodiments may be combined with each other, however, this combination must be based on that it can be realized by those of ordinary skill in the art. When the combination of the technical solutions is contradictory or cannot be realized, such a combination of the technical solutions should not be considered to exist, and is not within the protection scope of the present invention.

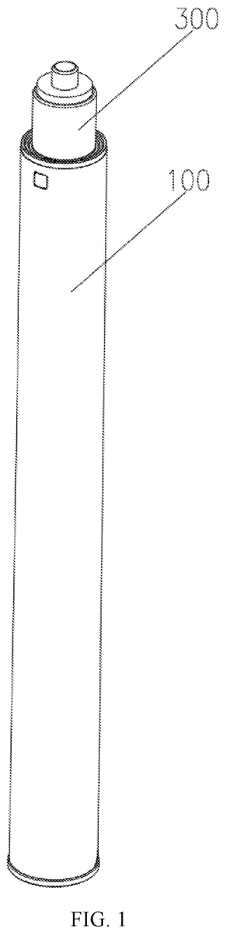

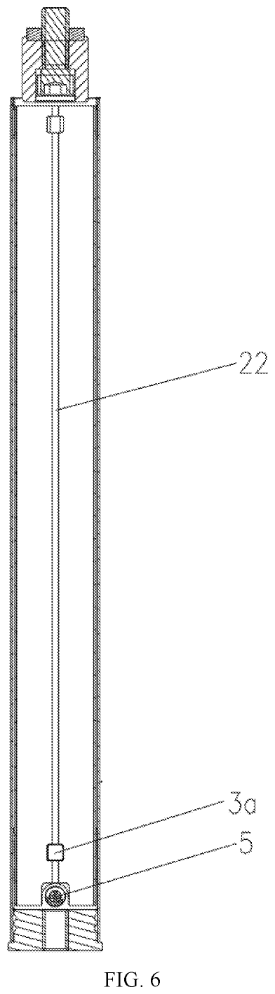

Referring to FIGS. 1 to 8, an embodiment of the present invention provides a telescopic rod comprising a plurality of sections of sequentially sleeved tube bodies 100, two adjacent sections of tube bodies 100 being an inner tube 1 and an outer tube 2 respectively, wherein the telescopic rod further comprises an elastic damping structure 200 arranged between gaps of the inner tube 1 and the outer tube 2; the elastic damping structure 200 comprises a first damping sleeve 3, a second damping sleeve 4 and a spring 5, the inner tube 1 is sleeved on inner sides of the first damping sleeve 3 and the second damping sleeve 4, the inner tube 1 is connected to the first damping sleeve 3 and the second damping sleeve 4, two ends of the spring 5 abut against the first damping sleeve 3 and the second damping sleeve 4 respectively, and the spring 5 drives the first damping sleeve 3 and the second damping sleeve 4 to move in opposite directions, so that the inner tube 1, the elastic damping structure 200 and the outer tube 2 are tightly attached; and a third damping sleeve 21 is further sleeved on the outer tube 2, the third damping sleeve 21 comprises a snap ring 21a and a limiting member 21b, the snap ring 21a is lapped at one end of the outer tube 2, the limiting member 21b is formed by extending from the snap ring 21a and extends between the outer tube 2 and the inner tube 1, and the limiting member 21b cooperates with the first damping sleeve 3 and/or the second damping sleeve 4 to limit the inner tube 1.

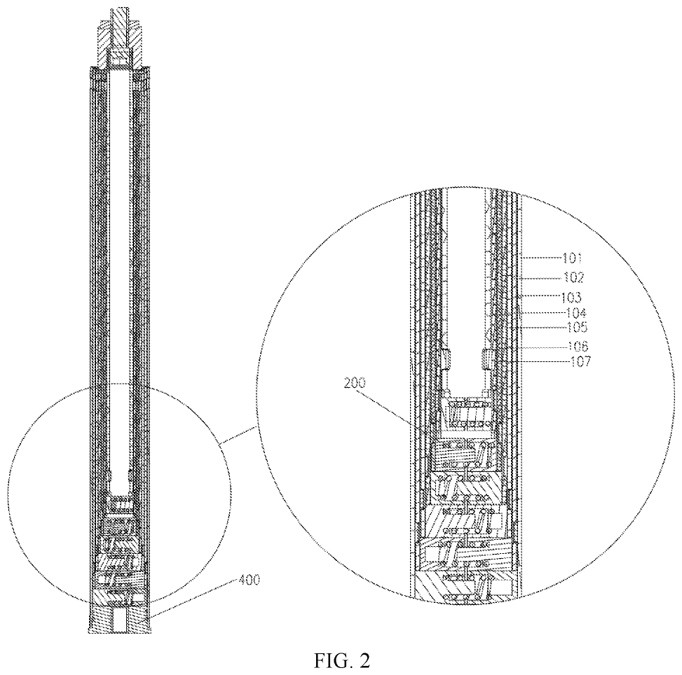

In a specific implementation, referring to FIGS. 1 to 2, the telescopic rod is sequentially sleeved from inside to outside by seven sections of tube bodies 100, the tube body 100 is a hollow pipeline structure, the seven sections of tube bodies 100 comprise a first tube body 101, a second tube body 102, a third tube body 103, a fourth tube body 104, a fifth tube body 105, a sixth tube body 106 and a seventh tube body 107 in an order from large to small tube diameter, and the adjacent pipe bodies can move relatively axially. Due to the design of the multi-section tube body, a length of the telescopic rod can be freely adjusted by a user based on a requirement, so that the telescopic rod can be adjusted more flexibly. Meanwhile, an elastic damping structure 200 is arranged between every two adjacent sections of pipe bodies, so that the fit gap between the adjacent pipe bodies is eliminated to the maximum extent, and the shaking and jitter of the telescopic rod in the use process are reduced.

The telescopic rod is further provided with a top cover 300, a bottom cover 400 and an anti-slip handle sleeve, the top cover 300 and the seventh tube body 107 can be mounted in a threaded connection manner, the bottom cover 400 and the first tube body 101 are mounted in a threaded connection manner, and the anti-slip handle sleeve is sleeved on an outer side of the outer tube 2. The bottom cover 400 is used to support the whole structure of the telescopic rod, so that the telescopic rod can bear force and maintain stability, and the anti-slip handle sleeve provides a good anti-slip effect and is convenient for a user to hold.

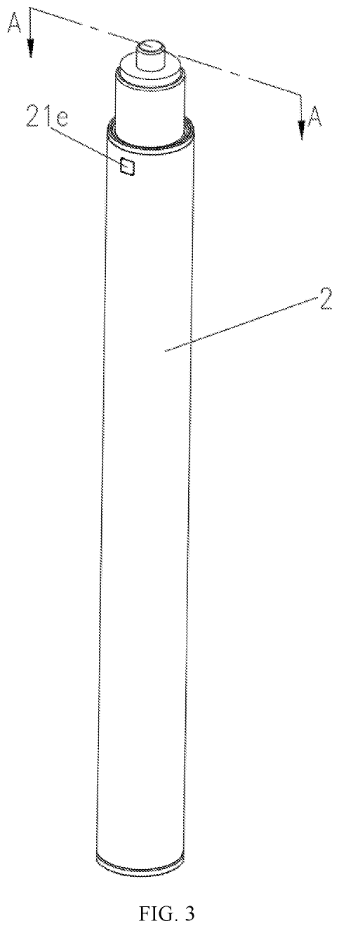

For convenience of description, in the following embodiments, FIGS. 3 to 8 provide an example of a telescopic rod having two sections of tube bodies, a tube body positioned at an inner layer of two adjacent tube bodies is an inner tube 1, a tube body positioned at an outer layer is an outer tube 2, the inner tube 1 and the outer tube 2 are relative concepts, and the inner tube 1 is an inner tube 1 relative to an outer tube body and is an outer tube 2 relative to an inner tube body. The same goes for the outer tube 2.

Specifically, the first damping sleeve 3 and the second damping sleeve 4 are a structure that achieves a damping effect and are made of flexible materials. The flexible materials include but are not limited to rubber and plastic, and the damping sleeves play the role of buffering and adhesion. The first damping sleeve 3 and the second damping sleeve 4 cooperate with the spring 5, so that the inner tube 1, the elastic damping structure 200 and the outer tube 2 can be always tightly attached, the fit gaps among the inner tube, the elastic damping structure and the outer tube are eliminated, and shaking of the telescopic rod caused by the fit gap of the inner tube body is solved. The first damping sleeve 3 and the second damping sleeve 4 are movably sleeved on the inner tube 1, and a connecting structure can be arranged between the first damping sleeve 3 and the inner tube 1 and between the second damping sleeve 4 and the inner tube so as to constrain the elastic damping structure 200 on the inner tube 1, and the first damping sleeve 3 and the second damping sleeve 4 cannot be separated from the inner tube 1 without affecting the relative movement of the two damping sleeves.

Further, the first spring seat 31 and the second spring seat 41 are used to fix and support the spring 5, the first spring seat 31 and the second spring seat 41 may adopt a boss structure with a slot inside, and an end of the spring 5 extends into the slot to achieve positioning and supporting. The first spring seat 31 and the first damping sleeve 3 are formed as an integral structure, and the second spring seat 41 and the second damping sleeve 4 are formed as an integral structure. The design of the first spring seat 31 and the second spring seat 41 can provide the mounting space for the spring 5 and limit an elastic expansion and contraction direction, which is beneficial to improving the stability of the mounting structure of the spring 5.

During the working process of the telescopic rod, the inner tube 1 and the elastic damping structure 200 slide along the inner wall of the outer tube 2, and an elastic force of the elastic member always acts on the inner tube 1 and is transmitted to the outer tube 2 through the elastic damping structure 200, so that the inner tube 1, the elastic damping structure 200 and the outer tube 2 can be always tightly attached, the fit gaps among the inner tube, the elastic damping structure and the outer tube are eliminated, and shaking of the telescopic rod caused by the fit gap between the inner tube bodies is solved. This can provide more durable and stable support for a photographing device supported on the telescopic rod. This method of using the spring 5 to exert an elastic force on the damping sleeves at two ends to form friction damping with the inner wall of the outer tube 2 avoids resistance attenuation caused by material fatigue and external temperature environment, and is also beneficial to providing more durable and stable support for a photographing device supported on the telescopic rod.

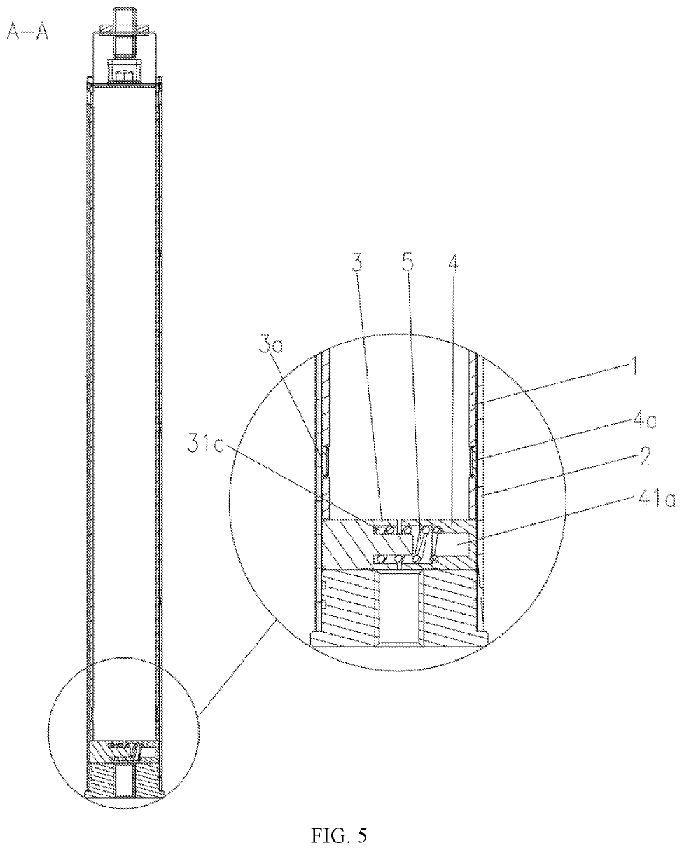

Referring to FIGS. 5 to 7, a spring column 31b is provided on the first mounting groove 31a, and the spring 5 is sleeved outside the spring column 31b. The spring column 31b may be a cylindrical column, and an end of the spring 5 is sleeved on the column, so as to achieve mounting and positioning of the spring 5. The first spring seat 31 passes through an inner diameter of the spring 5 by the spring column 31b, so that the spring 5 and the first damping sleeve 3 are sleeved. In addition, one end that is of the spring 5 and that faces away from the first damping sleeve 3 extends into a second mounting groove 41a of the second damping sleeve 4, and the second mounting groove 41a is sleeved on an outer diameter side of the spring 5, so that the spring 5 and the second damping sleeve 4 are sleeved.

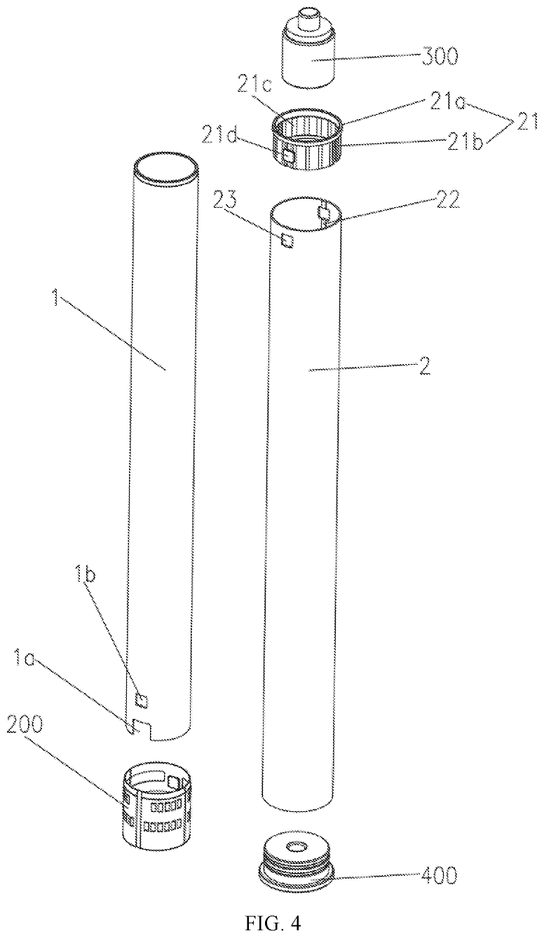

Referring to FIGS. 4 to 8, in an embodiment, a third damping sleeve 21 is further sleeved on the outer tube 2, the third damping sleeve 21 comprises a snap ring 21a and a limiting member 21b, the snap ring 21a is lapped at one end of the outer tube 2, the limiting member 21b is formed by extending from the snap ring 21a and extends between the outer tube 2 and the inner tube 1, and the limiting member 21b cooperates with the first damping sleeve 3 and/or the second damping sleeve 4 to limit the inner tube 1. The snap ring 21a is of a ring structure and is used to fixedly connect the third damping sleeve 21 and the outer tube 2, so that the position stability of the third damping sleeve 21 is ensured. The limiting member 21b can also be designed as a ring structure. When the inner tube 1 and the elastic damping structure 200 slide along an inner wall of the outer tube 2 until the inner tube 1 slides to a critical position, and an end of the first damping sleeve 3 and/or the second damping sleeve 4 abuts against an end of the third damping sleeve 21 to limit a displacement range of the inner tube 1. This design helps to maintain the stability and accuracy of the telescopic rod and prevent the inner tube 1 from deviating from a predetermined position.

Referring to FIGS. 4 to 8, in an embodiment, a plurality of first elastic structures are convexly provided on one side that is of the first damping sleeve 3 and/or the second damping sleeve 4 and that is close to the outer tube 2, and the first elastic structure elastically abuts against an inner wall of the outer tube 2. The first elastic structure elastically abuts against the inner wall of the outer tube 2, and the contact area and the contact force between the damping sleeve and the outer tube 2 are increased, so that the friction force and the tightness between the elastic damping structure 200 and the outer tube 2 are enhanced, and a better damping effect is provided. A plurality of first elastic structures 3b are provided on the first damping sleeve 3, and a plurality of first elastic structures 4b are provided on the second damping sleeve.

In a specific implementation, if the inner tube 1 is attached to the second damping sleeve 4 under the action of the spring 5, the gap between the inner tube 1 and the first damping sleeve 3 on the other side is increased, and the gap may also cause the shaking of the telescopic rod. Therefore, in an optional embodiment, a plurality of arched third elastic structures are convexly provided on one side that is of the first damping sleeve 3 and/or the second damping sleeve 4 and that faces away from the outer tube 2. By arranging the plurality of third elastic structures that arch inward, the third elastic structures can elastically abut against the outer wall of the inner tube 1, thereby perfectly eliminating the gap between the inner tube 1 and the first damping sleeve 3. This not only makes the whole telescopic rod structure less prone to shaking due to the gap, but also keeps the tight attachment between the components under the condition that a small amount of processing errors exist in the inner tube 1, the outer tube 2, the first damping sleeve 3 and the second damping sleeve 4. Therefore, the size precision control requirement on the inner tube 1, the outer tube 2, the first damping sleeve 3 and the second damping sleeve 4 is greatly reduced, and the cost is reduced.

Referring to FIGS. 4 to 8, in an embodiment, inner walls of the first spring seat 31 and the second spring seat 41 are respectively provided with a first mounting groove 31a and a second mounting groove 41a each with an opening at one end, the first mounting groove 31a and the second mounting groove 41a communicate with each other, and two ends of the spring 5 respectively abut against bottoms of the first mounting groove 31a and the second mounting groove 41a.

Specifically, the first spring seat 31 and the second spring seat 41 use boss structures with mounting slots formed inside, an end of the spring 5 extends into the slots to achieve positioning and supporting. In an optional example, an outer contour of the first spring seat 31 is matched with an outer contour of the second spring seat 41, and the two spring seats are butted to form a whole, so that the integral attractiveness and sealing performance are improved, and the support capacity of the spring 5 is enhanced. The first mounting groove 31a is a through groove with one end open along a lateral direction of the first spring seat 31, and the second mounting groove 41a is a through groove with one end open along a lateral direction of the second spring seat 41. A part of the spring 5 is movably arranged in the first mounting groove 31a, the other part of the spring is movably arranged in the second mounting groove 41a, and two ends of the spring 5 abut against the bottoms of the first mounting groove 31a and the second mounting groove 41a respectively. With a structural form in which the elastic member is arranged in the mounting groove in the mounting seat, the mounting groove can provide the mounting space for the elastic member and limit an elastic expansion and contraction direction, which is beneficial to improving the stability of the mounting structure of the elastic member.

Referring to FIGS. 4 to 5, in an embodiment, two sides of a tube wall of the inner tube 1 are provided with clearance through holes 1a for the first spring seat 31 and the second spring seat 41 to pass through, and the two clearance through holes 1a are oppositely arranged.

Specifically, the first spring seat 31 and the second spring seat 41 separately extend into the oppositely arranged clearance through holes 1a at two sides, so as to extend into the inner cavity of the inner tube 1. One end of the spring 5 abuts against the bottom of the first mounting groove 31a, and the other end of the spring abuts against the bottom of the second installation groove 41a. The elastic force of the spring 5 drives the inner tube 1, the elastic damping structure 200 and the outer tube 2 to attach tightly, so that the frictional damping is formed between the damping member and the inner wall of the outer tube 2. With this arrangement, the spring 5 can be placed in the inner cavity of the inner tube 1 without occupying the space between the inner tube 1 and the outer tube 2.

Referring to FIGS. 4 to 5, in an embodiment, the clearance through hole 1a is positioned at an end of the inner tube 1, the tube wall of the inner tube 1 is further provided with a first mounting hole 1b, and the first damping sleeve 3 and the second damping sleeve 4 are convexly provided with first mounting convex blocks that cooperate with the first mounting holes 1b.

Specifically, the clearance through hole 1a is a notch provided on a tube wall of a lower end of the inner tube 1, and the spring seat and the inner wall of the damping sleeve are integrally formed and extend to the inner cavity of the inner tube 1 through the clearance through hole 1a. In an optional embodiment, the damping sleeve may further be provided with a mounting bottom plate, and the mounting bottom plate is positioned below the spring seat and extends towards an end face of the inner tube 1.

Further, since the clearance through hole 1a is positioned at an end of the inner tube 1, which loses an effect of constraining the elastic damping structure 200 on the inner tube 1, a first mounting hole 1b and a first mounting convex block which are matched are provided, and the first damping sleeve 3 and the second damping sleeve 4 are mounted by inserting the respective first mounting convex blocks into the corresponding first mounting holes 1b on the inner tube 1. The first damping sleeve 3 is provided with a first mounting convex block 3a, and the second damping sleeve 4 is provided with a first mounting convex block 4a.

Referring to FIGS. 4 to 8, in an embodiment, a second mounting convex block 21d and a plurality of second elastic structures 21c are convexly arranged on one side that is of the limiting member 21b and that is close to the inner tube 1, the tube wall of the outer tube 2 is further provided with a second mounting hole 23 cooperating with the second mounting convex block 21d, and the second elastic structure 21c elastically abuts against the inner tube 1. The embodiments of the second mounting convex blocks 21d, the second mounting holes 23 and the second elastic structures 21c are similar to the embodiments of the first mounting convex block, the first mounting hole 1b and the first elastic structure. Reference may be made to the corresponding structures and working principles in the foregoing embodiments, and details are not described herein again.

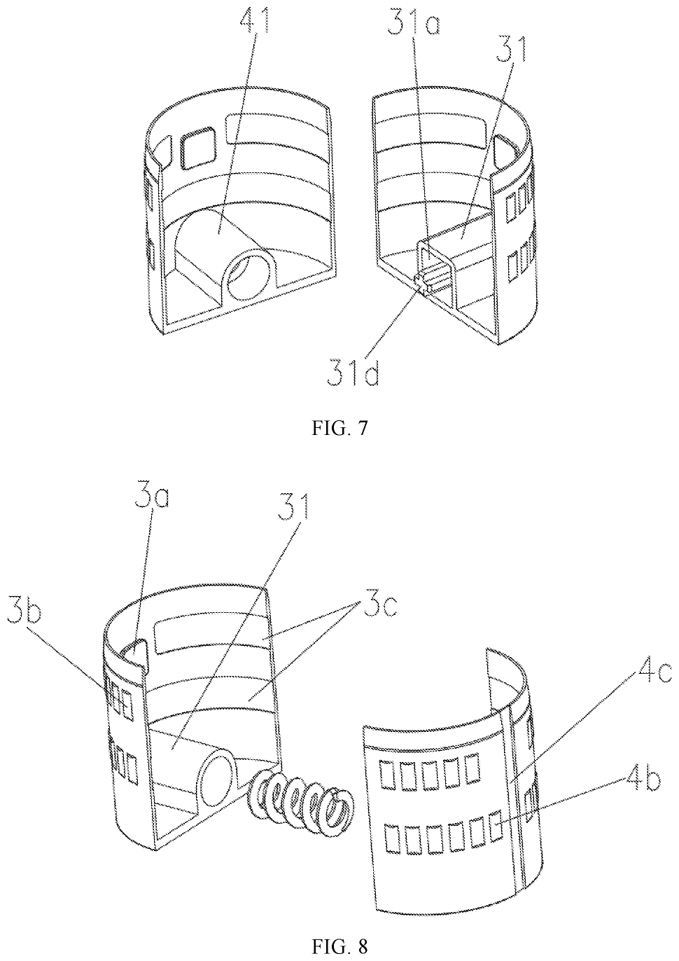

Referring to FIGS. 7 to 8, in an optional embodiment, a first connecting convex ring (not shown) is convexly arranged on the first spring seat 31, a first connecting groove (not shown) matched with the first connecting convex ring is formed in the second spring seat 41, a second connecting convex ring (not shown) is convexly arranged on the second spring seat 41, a second connecting groove (not shown) matched with the second connecting convex ring is formed in the first spring seat 31, and the first connecting convex ring and the second connecting convex ring are positioned on the same circular ring.

Specifically, the first connecting convex ring is a half-moon-shaped annular protrusion on an outer surface of the first spring seat 31, the first connecting groove refers to a groove formed on the second spring seat 41, the shape of which is matched with the first connecting convex ring, so that the first connecting groove and the first connecting convex ring can cooperate with each other and be nested together. This design can achieve a convenient and stable connection between the first spring seat 31 and the second spring seat 41. Similarly, the first spring seat 31 and the second spring seat 41 are respectively further provided with a second connecting groove and a second connecting convex ring which are matched with each other, so as to further achieve the stable consistency of a fixed connection. The first connecting convex ring and the second connecting convex ring are positioned on the same circular ring, which means that the two connecting convex rings are positioned on a circular contour on the same plane, that is, after the first connecting convex ring and the second connecting convex ring are respectively inserted in the first connecting groove and the second connecting groove, an outer contour of the first connecting convex ring is matched with an outer contour of the second connecting convex ring, and the two connecting convex rings are butted to form a whole, so that the integral attractiveness and sealing performance are improved, the tightness of the connection between the first spring seat 31 and the second spring seat 41 is enhanced, and the mounting stability is improved without affecting the elastic expansion and contraction of the spring 5.

Referring to FIGS. 4 to 6, in an embodiment, the inner wall of the outer tube 2 is convexly provided with a guide rib 22, an outer wall of the first damping sleeve 3 and/or the second damping sleeve 4 is provided with a guide groove 4c cooperating with the guide rib 22, and the first mounting hole 1b on the inner tube 1 is positioned on the guide rib 22.

Specifically, the guide rib 22 is a protruding strip structure, and a plurality of guide ribs can be provided. The guide groove 4c is a U-shaped groove recessed along an outer wall surface of the first damping sleeve 3 and/or the second damping sleeve 4, and the number and position of the guide grooves 4c are corresponding to the plurality of guide ribs 22. The guide rib 22 plays a role in guiding the movement of the first damping sleeve 3 and the second damping sleeve 4 to facilitate the sliding of the elastic damping structure 200 and the inner tube 1 along the guide rib 22 on the outer tube 2.

Referring to FIGS. 1 to 6, the telescopic rod is further provided with a top cover 300 and a bottom cover 400 and an anti-slip handle sleeve, the top cover 300 is mounted on the inner tube 1, and the bottom cover 400 is mounted on the outer tube 2, and the anti-slip handle sleeve is sleeved on an outer side of the outer tube 2. In a case of multi-section pipe bodies, the top cover 300 is mounted on an innermost tube body, and the bottom cover 400 is mounted on an outermost tube body. As shown in FIGS. 1 and 2, the top cover 300 is mounted on an end of an innermost seventh tube body 107, and the bottom cover 400 is mounted on an end of an outermost first tube body 101.

The above mentioned contents are only optional embodiments of the present invention and are not intended to limit the patent scope of the present invention, and under the inventive concept of the present invention, the equivalent structural transformations made by using the contents of the specification and the drawings of the present invention, or direct/indirect applications to other related technical fields, are all included in the patent protection scope of the present invention.

1. A telescopic rod, comprising: a plurality of sections of sequentially sleeved tube bodies, two adjacent sections of tube bodies being an inner tube and an outer tube respectively; wherein the telescopic rod further comprises an elastic damping structure arranged between gaps of the inner tube and the outer tube;
the elastic damping structure comprises a first damping sleeve, a second damping sleeve and a spring, the inner tube is sleeved on inner sides of the first damping sleeve and the second damping sleeve, the inner tube is connected to the first damping sleeve and the second damping sleeve, two ends of the spring abut against the first damping sleeve and the second damping sleeve respectively, and the spring drives the first damping sleeve and the second damping sleeve to move in opposite directions, so that the inner tube, the elastic damping structure and the outer tube are tightly attached; and
a third damping sleeve is further sleeved on the outer tube, the third damping sleeve comprises a snap ring and a limiting member, the snap ring is lapped at one end of the outer tube, the limiting member is formed by extending from the snap ring and extends between the outer tube and the inner tube, and the limiting member cooperates with the first damping sleeve and/or the second damping sleeve to limit the inner tube.

2. The telescopic rod according to claim 1, wherein a plurality of first elastic structures are convexly provided on one side that is of the first damping sleeve and/or the second damping sleeve and that is close to the outer tube, and the first elastic structure elastically abuts against an inner wall of the outer tube.

3. The telescopic rod according to claim 1, wherein a first spring seat is arranged on the first damping sleeve, a second spring seat cooperating with the first spring seat is arranged on the second damping sleeve, the spring is arranged between the first spring seat and the second spring seat, inner walls of the first spring seat and the second spring seat are respectively provided with a first mounting groove and a second mounting groove each with an opening at one end, the first mounting groove and the second mounting groove communicate with each other, and two ends of the spring respectively abut against bottoms of the first mounting groove and the second mounting groove.

4. The telescopic rod according to claim 3, wherein two sides of a tube wall of the inner tube are provided with clearance through holes for the first spring seat and the second spring seat to pass through, and the two clearance through holes are oppositely arranged.

5. The telescopic rod according to claim 4, wherein the clearance through hole is positioned at an end of the inner tube, the tube wall of the inner tube is further provided with a first mounting hole, and the first damping sleeve and the second damping sleeve are convexly provided with first mounting convex blocks that cooperate with the first mounting holes.

6. The telescopic rod according to claim 1, wherein a second mounting convex block and a plurality of second elastic structures are convexly arranged on one side that is of the limiting member and that is close to the inner tube, the tube wall of the outer tube is further provided with a second mounting hole cooperating with the second mounting convex block, and the second elastic structure elastically abuts against the inner tube.

7. The telescopic rod according to claim 3, wherein a spring column is provided on the first mounting groove, and the spring is sleeved outside the spring column.

8. The telescopic rod according to claim 3, wherein a plurality of arched third elastic structures are convexly arranged on one side that is of the first damping sleeve and/or the second damping sleeve and that faces away from the outer tube.

9. The telescopic rod according to claim 5, wherein the inner wall of the outer tube is convexly provided with a guide rib, an outer wall of the first damping sleeve and/or the second damping sleeve is provided with a guide groove cooperating with the guide rib, and the first mounting hole on the inner tube is positioned on the guide rib.

10. The telescopic rod according to claim 1, wherein the telescopic rod is further provided with a top cover and a bottom cover, the top cover is mounted on the inner tube, and the bottom cover is mounted on the outer tube.
